(19) United States
(12) Patent Application Publication
(10) Pub. No.: US 2017/0249974 A1
(43) Pub. Date: Aug. 31, 2017

(54) Adapter for Video Recorders

(71) Applicant: Charles Christopher Mueller, Springfield, MO (US)

(72) Inventor: Charles Christopher Mueller, Springfield, MO (US)

(21) Appl. No.: 15/057,064

(22) Filed: Feb. 29, 2016

(51) Int. Cl. G11B 33/12; H04N 5/765; H04N 5/907; G11B 20/10

(52) U.S. Cl. CPC G11B 33/122; G11B 20/10527; H04N 5/765; H04N 5/907

(57) ABSTRACT

This invention relates to an adapter for recording to removable storage device from a certain family of digital video recorders. More particularly, this adapter allows AJA® Video Systems, Inc's Ki Pro® and Ki Pro® Rack digital video recorders to record to removable storage devices such as a hard disk drive or solid state drive.

### BACKGROUND

1. Technical Field

This invention relates to an adapter for recording to removable storage device from a certain family of digital video recorders. More particularly, this adapter allows AJA® Video Systems, Inc's Ki Pro® and Ki Pro® Rack digital video recorders to record to removable storage devices such as a hard disk drive or solid state drive.

2. Description of Related Art

In the field of digital video recorders, hard disk drives (HDD) and solid state drives (SSD) are common types of recording and storage media. Many digital video recorders are capable of recording to a HDD or SSD (e.g. Blackmagic Design's Hyperdeck line, Atomos' Ronin). Industry standard HDD transfer interfaces (e.g. USB to SATA adapter cable, Firewire to SATA docking station) can access the recorded content.

AJA® Video Systems, Inc's Ki Pro® and Ki Pro® Rack are popular digital video recorders which record to a proprietary storage cartridge more commonly known as a KiStor storage module. The recorder is electrically connected to a storage cartridge through mateable Slimline Serial Advanced Technology Adapte (SATA) connectors. The Slimline SATA connectors have 6 pins on the power/control segment and 7 pins on the data segment.

As is well known to a person of ordinary skill in the art, to record from a Ki Pro® digital recorder, the operator slidably inserts a KiStor storage cartridge into an opening (see, for example, 702 FIG. 2) on the recorder. Once the storage cartridge is fully inserted, an electrical connection is made, the storage cartridge is detected by the recorder and the storage device disposed inside the storage cartridge is automatically mounted. Once the storage device mounted, the recorder is ready to record. We note that the presence of a storage cartridge is detected by electrically grounding a certain specific pin on the power segment side of the video recorder's connector (see, for example, 704 FIG. 2). This is accomplished by bussing the corresponding pin on the storage cartridge's connector to ground.

In many cases, the recorded content is transferred from the storage cartridge to an external HDD for various reasons including: physically transferring the content to a client, archiving the content and/or to free up space thereby making the cartridge available for further recording. As is well known to a person of ordinary skill in the art, one way to access the recorded content is to connect the storage cartridge's built-in transfer interface connector (e.g. Firewire 400/800, USB 3.0), different than the Slimline SATA connector, to a host device such as a Personal Computer (PC). Some of these interfaces are subject to standards setting organizations and the scope of such standard-defined interfaces are meant to include all current, past and future specifications that are compatible with the invention disclosed. The use of terms defined by a standard in this disclosure is for the sole purpose of conveniently describing the functional elements represented by that standard.

It should be noted that the storage technology (e.g. spinning disks, solid state), the storage capacity (e.g. 250 GB, 500 GB, 1 TB) and transfer interface (e.g. Firewire 400/800, USB 3.0) are all fixed characteristics of a KiStor storage cartridge. To change any of these characteristics requires the purchase of a new KiStor module. Therefore, what is needed is an adapter for recording from the Ki Pro® digital video recorder to a removable storage device which overcome one or more deficiencies in the prior art.

Henceforth when we use the phrase “an associated video recorder” we are intending to cover Ki Pro®, Ki Pro® Rack digital video recorders and, more generally, any digital video recorder which records to a KiStor storage cartridge. When we use the phrase “an associated storage cartridge” we are referring to a KiStor storage cartridge.

### SUMMARY

The present disclosure relates to an adapter for recording to a removable data storage device from an associated video recorder. More specifically, the present adapter allows AJA® Video System's, Inc. Ki Pro® and Ki Pro® Rack digital video recorders to recorder directly to 2.5 inch hard disk drives and solid state drives. The adapter includes a first electrical connector which connects to a storage device, a second electrical connector which connects to an associated video recorder and circuitry electrically interconnecting these connectors in such a way as to provide: voltage conversion, storage device detection and data transmission.

According to one embodiment of the present invention, the adapter is disposed in a housing having an external surface dimensioned to be received within an opening on an associated video recorder and having a cavity sized to receive a storage device. An ejection mechanism is utilized to facilitate in disconnecting the storage device from the adapter.

According to another embodiment, the adapter consists of molded connectors electrically connected to flexible cables which may be electrically interconnected through a circuit board.

Recording directly to HDDs and SSDs eliminates time-consuming data transfers, allows easy and cost effective means for changing: storage device technology, storage capacity and transfer interface.

Still other benefits and advantages of the invention will become apparent to those skilled in the art to which it pertains upon reading and understanding of the following detailed specification.

### BREIF DESCRIPTIONS OF THE DRAWINGS

FIG. 1 is an exploded, perspective view of an exemplary embodiment of an adapter and a HDD.

FIG. 2 is an exploded partial perspective view of an associated video recorder and the adapter, with HDD disposed inside, of FIG. 1.

FIG. 3 is an exploded, perspective view of the adapter of FIG. 1.

FIG. 4 and FIG. 5 are assembled, isometric views of the adapter of FIG. 1, but viewed from different perspectives.

FIG. 6 is a perspective view of the inside structure of the lower housing of the adapter of FIG. 1.

FIG. 7 is a perspective view of the lower housing of FIG. 6 with the ejector assembly in the depressed state and a first circuit board and a second circuit board in their respective assembled positions.

FIG. 8 is a perspective view of the inside structure of the upper housing of the adapter of FIG. 1.

FIG. 9 is a flow diagram of an exemplary method for energizing a removable storage device from an associated video recorder.

FIG. 10 is a circuit block diagram of voltage converting and storage device detection structures.

FIG. 11 is a schematic view of an alternative embodiment of an adapter.

### DETAILED DESCRIPTIONS OF THE PREFERRED EMBODIMENTS

The disclosure, including the accompanying drawings, is illustrated by way of example and not by way of limitation. It should be noted that references to “an” or “one” embodiment in this disclosure are not necessarily to the same embodiment, and such references means at least one.

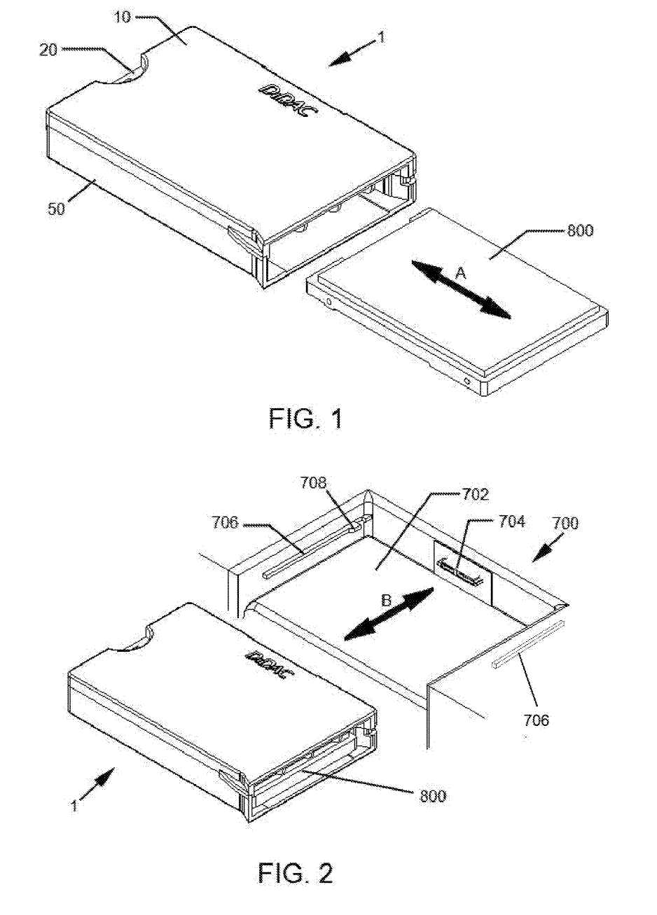

FIG. 1 is a perspective view of one embodiment of an adapter 1 for slidably receiving, in the directions A, one embodiment of a storage device 800. In the embodiment shown, the adapter 1 has an upper housing 10 and a lower housing 50 which, when assembled, define a cavity sized to slidably receive a 2.5 inch hard disk drive in the directions A.

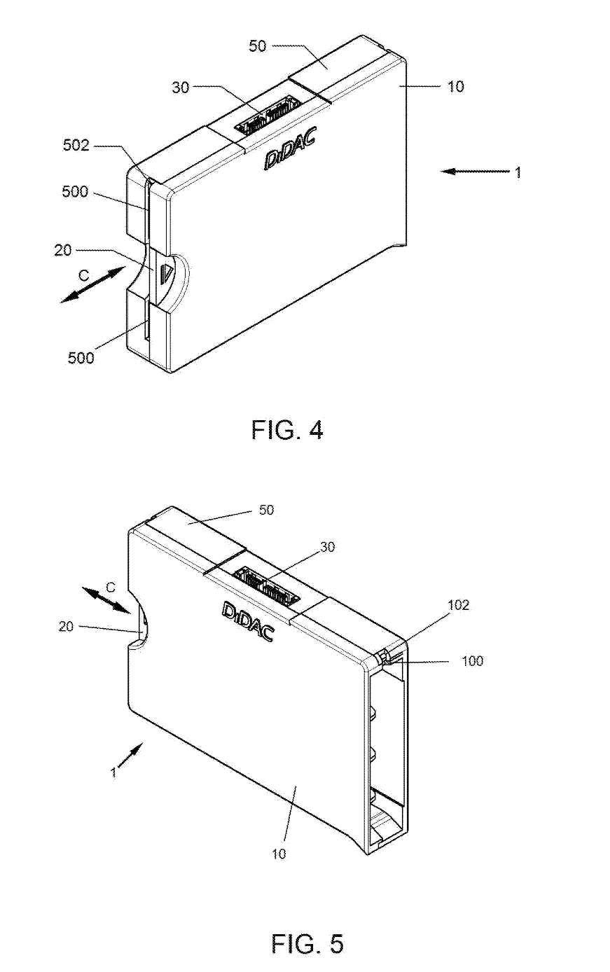

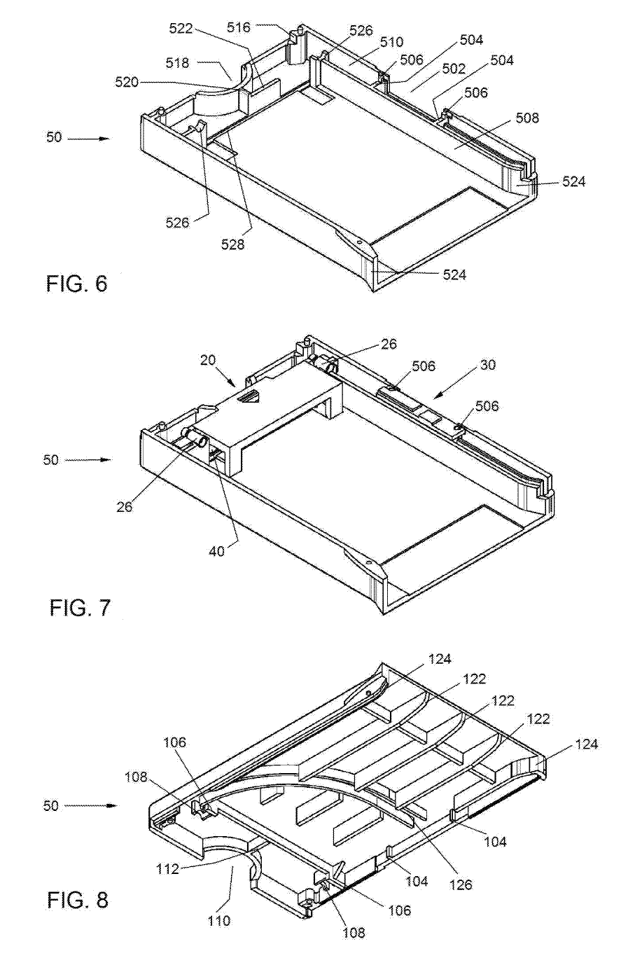

FIG. 2 is a partial perspective view of one embodiment of an associated video recorder 700 and the adapter 1, with a storage device 800 disposed inside. The associated video recorder 700 may have an opening 702 for slidably receiving in the directions B an associated storage cartridge (not shown) therein, wherein the opening may have guide rails 706, a latching mechanism 708 and an interface connector 704 in predetermined locations. In this embodiment of the adapter 1, the upper housing 10 and lower housing 50, when assembled, define an external surface dimensioned to be received within said opening 702 in an associated video recorder 700 including guide channels 500 and 100 (see FIG. 4 and FIG. 5), a latching post 516 (see FIG. 6) and a mateable connector 30 (see FIG. 4 and FIG. 5) in predetermined locations.

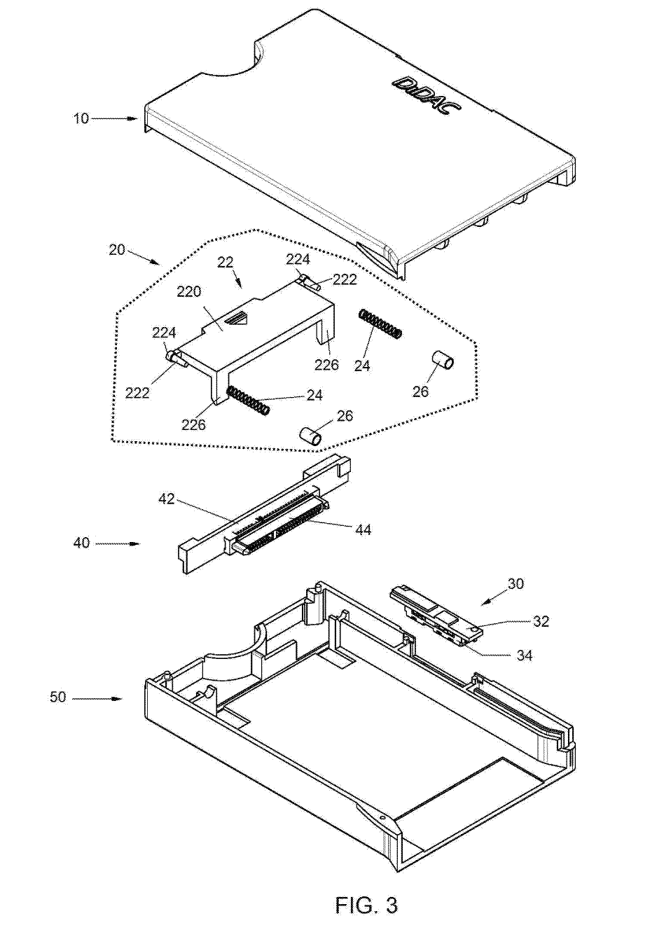

FIG. 3 is a perspective, exploded view of adapter 1 which includes an upper housing 10, an ejector assembly 20, a first circuit board 30, a second circuit board 40 and a lower housing 50. When assembled, upper housing 10 is fixed to lower housing 50 wherein at least a portion of ejector assembly 20, at least a portion of first circuit board 30 and at least a portion of second circuit board 40 are sandwiched between upper housing 10 and lower housing 50.

In this embodiment, the ejector assembly 20 includes: an ejector 22; a plurality of springs 24; and a plurality of tubes 26. The inner diameter (I.D.) of the tube 26 is slightly larger than the outer diameter (O.D.) of the spring 24 allowing the spring 24 to compress inside of the tube 26 (see FIG. 7 and FIG. 8). The ejector 22 consists of a top, primarily rectangle, piece 220 and extruding downward on either end of the front edge of the top piece 220 are two ejector legs 226. Located at the back and on each side of the top piece 220 are two support ears 224 from which spring alignment cones 222 are extruded. The O.D. of the spring alignment cones 222 is less than the I.D. of the springs 24.

In this embodiment, the first circuit board 30 includes a circuit board 32 and a horizontally mounted Slimline SATA connector 34 for interfacing with an associated video recorder (not shown).

In this embodiment, the second circuit board 40 includes a circuit board 42 and a vertically mounted connector 44 for interfacing with a removable storage device (not shown). In this embodiment the connector 44 is a vertical mounted SATA 15-pin power+7-pin data connector. We note, in this embodiment, the connectors 34 and 44 are mounted on different circuit boards 32 and 42, this may not always be the case.

Referring to FIGS. 4 & 5, to disconnect a removable storage device (not shown) from adapter 1, an ejector assembly 20 is slid in the direction of arrow C. The ejector assembly's spring-return feature returns the assembly 20 to its resting position. When the upper housing 10 and lower housing 50 are assembled they define empty spaces called the guide channels 100 & 500 which, with their corresponding guide rails (see 706 FIG. 2), align and guide the adapter 1 into the associated video recorder's opening (see 702 FIG. 2). We note that the ejector assembly 20 sits above the guide channel 500. We note the connector 34 attached the first circuit board 30 is mounted flush with the back of the adapter housings 10 and 50.

Referring to FIGS. 6 & 7, the interior structure of one embodiment of the lower housing 50 includes: a receptacle 502 for receiving a first circuit board 30, alignment pins 506 and first support walls 504 align and support the first circuit board 30, a latching post 516 which engages with a latching mechanism (see 708, FIG. 1) of an associated video recorder, tube saddles 526 to support tubes 26, a lower D-shaped receptacle 518 allowing ejector assembly 20 to be depressed, an ejector support wall 520 to support and align ejector 20, a second circuit board support wall 522 and a second receptacle 528 for slide disposition and support of second circuit board 40, and a lower internal wall 508 for aligning and guiding a storage device (not shown) and an empty space 510 for routing an electrical conductor such as a flexible cable for electrically interconnecting first circuit board 30 and second circuit board 40.

Referring to FIG. 8, the internal structure of one embodiment of the upper housing 10 includes: a plurality of alignment fins 122 to help align the storage device for insertion, two spring support walls 106 and tube cradles 108, a upper D-shaped receptacle 110, matching the lower D-shaped receptacle 518, allowing the ejector assembly (not shown) to be depressed, an ejector support wall 112 stabilizes the ejector (not shown), two PCB tabs 104 which fix first circuit board (not shown) in place, and a curved cable trough 126 which defines a conduit for routing an electrical connector such as a flexible cable for electrically interconnecting a first circuit board (not shown) and a second circuit board (not shown).

Referring to FIGS. 6, 7 & 8, when assembled, the tubes 26 are sandwiched between the tube cradles 108 of the upper housing 10 and the tube saddles 526 of the lower housing 50. When the ejector assembly 20 is slid forward, the springs 26 compress against their respective spring walls 106 and coil in their respective tubes 26. When the force is released from the ejector assembly 20, the springs 26 extend to their resting position and the ejector assembly 20 returns to its resting position. We note that in some embodiments, the insertion end of lower housing 50 and upper housing 10 may be flared outward 524 and 124 so that when assembled help guide and align insertion of storage device (not shown).

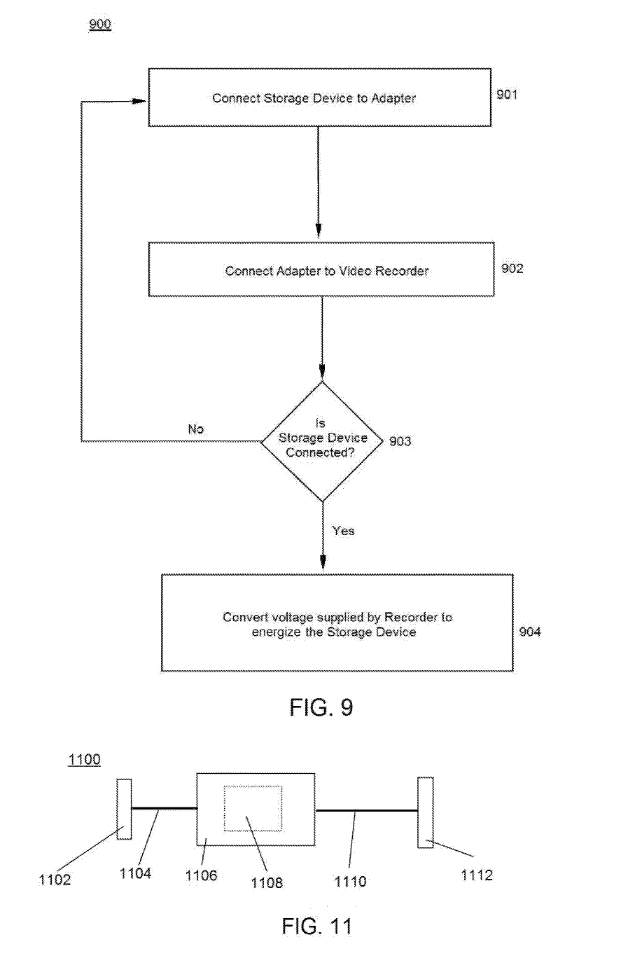

FIG. 9 shows a flow diagram of an exemplary method 900 for energizing a removable storage device from an associated video recorder. The first step 901 consists of connecting a storage device to the adapter via mateable electrical connectors such as SATA connectors. The second step 902 consists of connecting the adapter to an associated video recorder via mateable electrical connectors such as Slimline SATA connectors. As it is possible to perform the second step 902 without having completed the first step 901, we must detect the presence of the storage device, the third step 903, otherwise the recorder may enter an infinite loop state trying to mount an absent storage device. If a storage device is present and hence detected by the recorder then the forth step 904 consists of converting the voltage supplied by the recorder to energize the storage device.

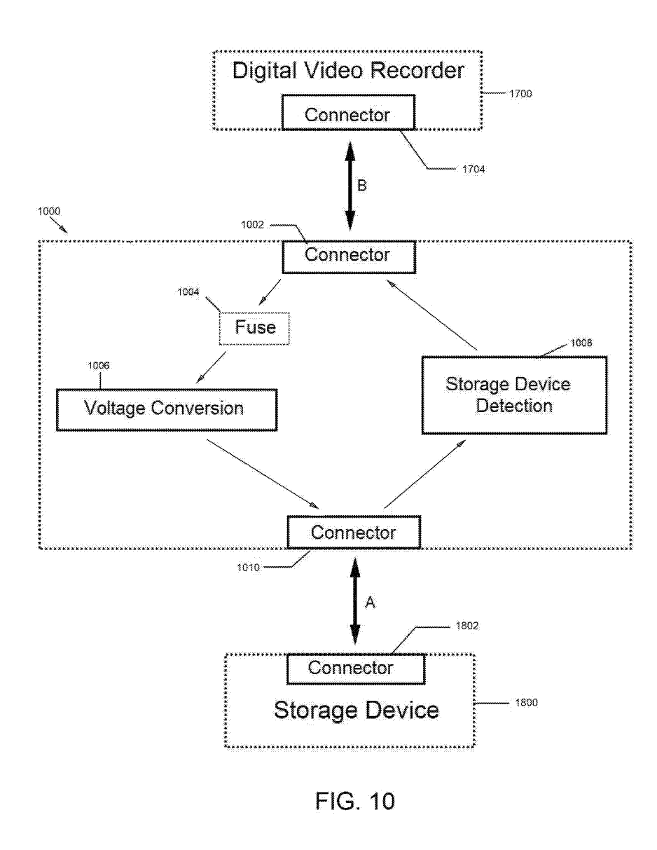

FIG. 10 shows a circuit block diagram of a voltage converting and storage device detecting structure 1000 according to the present invention. The presence of a storage cartridge is detected by electrically grounding a certain specific pin on the associated video recorder's connector 1704. In this embodiment, the corresponding pin on the adapter's first connector 1002 is electrically connected via an isolated conductive path (for example by flexible wire or a trace on a printed circuit board or any combination thereof) to a pin on the adapter's second connector 1010 corresponding to a ground pin on the power segment side of the storage device's connector 1802. Therefore the aforementioned certain specific pin on the associated video recorder's connector 1704 is electrically grounded if and only if a storage device is connected.

Once the storage device 1800 is detected, the associated video recorder's 12 VDC power is introduced through mateable connectors 1704 and 1002 to a circuit board which may be directed through a fuse 1004 or some other current limiting device to an electronically connected voltage converting unit 1006 for converting (by a DC/DC switching regulator, for example) 12 VDC into the voltage level required to energize storage device 1800 (5 VDC for a 2.5 inch HDD, for example) through mateable connectors 1010 and 1802.

We note that data is transmitted between the storage device 1800 and the video recorder 1700 by electrically connecting, in a one-to-one order preserving manner the data segment pins of the first connector 1002 and the data segment pins of the second connector 1010.

FIG. 11 is a schematic view of an alternative embodiment of an adapter 1100 for consisting of a molded Slimline SATA connector 1102 electrically connected to an electrical conductor such as a first flexible cable 1104. First flexible cable 1104 is electrically connected to a circuit board 1106 having a voltage converting circuit 1108. A second flexible cable 1110 electrically interconnects circuit board 1106 to a second molded electrical connector 1112 for interfacing with a storage device (not shown). The circuit board 1106 may included additional conducting paths for further electrically interconnecting Slimline SATA connector 1102 and second electrical connector 1112.

It is believed that the present embodiment and its advantages will be understood from the foregoing description, and it will be apparent that various changes may be made thereto without departing from the spirit and scope of the description or sacrificing all of their material advantages, the examples herein before described merely being an exemplary embodiment.

In the above description, at least one preferred embodiment has been described in detail with reference to the drawing annexed, and it I apparent that numerous changes, or modifications may be made without departing from the true spirit and scope thereof, as set forth in the claims below.

What is claimed is:

1. An adapter for recording to a removable data storage device from an associated digital video recorder, comprising:
a first electrical connector mateable with said storage device;
a second electrical connector different than the first connector mateable with said video recorder;
a first electrical circuit means for detecting the presence of the storage device to the video recorder;
a second electrical circuit means for converting voltage supplied by the video recorder to energize the storage device;
a third electrical circuit means for transmitting and receiving data between said video recorder and said storage device.

2. An adapter according to claim 1 wherein said first electrical connector is a SATA connector.

3. An adapter according to claim 1 wherein said second electrical connector is a Slimline SATA connector.

4. An adapter according to claim 1 wherein said storage device comprises a hard disk drive or a solid state drive.

5. An adapter according to claim 1 wherein said adapter is disposed inside an adapter housing comprising:
an external surface dimensioned to be received within an opening in said digital video recorder;
and having a cavity sized to receive at least a portion of said removable storage device.

6. An adapter according to claim 5 wherein said cavity is sized to receive at least a portion of a 2.5 inch hard disk drive or solid state drive.

7. An adapter according to claim 5 wherein said adapter housing comprises an ejection mechanism.

8. An adapter according to claim 5 wherein said cavity opening comprises alignment features.

9. A method for energizing a removable data storage device from an associated digital video recorder, comprising:
connecting a storage device to an associated digital video recorder;
communicating the presence of the storage device to the video recorder; and
converting voltage supplied by the video recorder to energize the storage device.

10. An adapter for recording to a removable data storage device from an associated digital video recorder, comprising:
a first electrical connector mateable with said storage device;
a second electrical connector different from the first mateable with said video recorder;
a first electrical circuit means for detecting the presence of the storage device to the video recorder;
a second electrical circuit means for transmitting and receiving data between said video recorder and said storage device;
an adapter housing with at least one circuit board disposed inside, the circuit board further comprising:
a voltage-converting unit for converting voltage introduced to a different voltage level and outputting a different voltage;
an electrical conductor for electrically interconnecting at least some of the power segment pins of said first connector to the output of said voltage-converting unit;
an electrical conductor for electrically interconnecting at least some of the power segment pins of said second connector to the input of said voltage-converting unit.

11. An adapter according to claim 10 wherein said first electrical connector is a SATA connector.

12. An adapter according to claim 10 wherein said second electrical connector is a Slimline SATA connector.

13. An adapter according to claim 10 wherein said storage device comprises a hard disk drive or a solid state drive.

14. An adapter according to claim 10 wherein said voltage-converting unit outputs 5 VDC.
